(19) United States
(12) Patent Application Publication
(10) Pub. No.: US 2019/0194812 A1
(43) Pub. Date: Jun. 27, 2019

(54) GAP-FILLING SEALING LAYER OF THERMAL BARRIER COATING

(71) Applicant: GM GLOBAL TECHNOLOGY OPERATIONS LLC, DETROIT, MI (US)

(72) Inventors: Michael J. Walker, Shelby Township, MI (US); Paul M. Najt, Bloomfield Hills, MI (US); Russell P. Durrett, Bloomfield Hills, MI (US); Peter P. Andruskiewicz, IV, Ann Arbor, MI (US)

(21) Appl. No.: 15/849,883

(22) Filed: Dec. 21, 2017

(51) Int. Cl. C23C 28/02; C23C 30/00; C22C 19/00; C22C 9/04; B32B 3/10; B32B 3/26; B32B 5/30; B32B 15/01

(52) U.S. Cl. CPC C23C 28/028; C01P 2006/32; C23C 28/021; C23C 30/005; C22C 19/002; C22C 9/04; B32B 3/10; B32B 3/26; B32B 5/30; B32B 15/01; B32B 2305/026; B32B 2307/304; B32B 2311/12; B32B 2311/20; B32B 2311/22; B32B 2311/30; C01P 2004/34; C01P 2004/61; C23C 28/023

(57) ABSTRACT

A multi-layer thermal barrier coating is provided that includes an insulating layer having an outer surface defining a plurality of crevices therein and a sealing layer bonded to the outer surface of the insulating layer. The sealing layer is substantially non-permeable and is configured to seal against the insulating layer. The sealing layer fills in at least a portion of the crevices. A method of forming a thermal barrier coating is also provided, which includes a step of providing a plurality of hollow round microstructures bonded together, each having a diameter in the range of 10 to 100 microns to create an insulating layer. The method further includes depositing a plurality of metal particles onto the insulating layer and heating the plurality of metal particles to form a substantially non-permeable sealing layer over the insulating layer.

### STATEMENT REGARDING FEDERALLY FUNDED RESEARCH OR DEVELOPMENT

This invention was made with government support under contract no. DE-EE0007754 awarded by the United States Department of Energy. The government has certain rights in the invention.

### TECHNICAL FIELD

The disclosure relates generally to a thermal barrier layer, which may be referred to as a thermal barrier coating (TBC), for protecting components subject to high-temperature gasses, and a method of forming the same.

### INTRODUCTION

Internal combustion engines include a plurality of cylinders, a plurality of pistons, at least one intake port, and at least one exhaust port. The cylinders each include surfaces that define a combustion chamber. One or more surfaces of the internal combustion engine may be coated with thermal barrier coatings, or multi-layer thermal barriers, to improve the heat transfer characteristics of the internal combustion engine and minimize heat loss within the combustion chamber. For example, such a coating system is desired for insulating the hot combustion gasses from the cold, water-cooled engine block, to avoid energy loss by transferring heat from the combustion gasses to the cooling water.

A sealing layer may be provided over an insulating layer to effectively seal the component from the particles that may be present in the combustion gasses. In addition, the surface of the coating system should follow the temperature of the combustion gasses, including cooling down rapidly, to avoid heating up the fuel-air mixture before ignition to avoid knocking. Therefore, the sealing layer is provided as a very thin layer that can follow the temperature of the adjacent gasses. However, given the porosity of the insulating layer, the very thin sealing layer only bonds to some of the surface of the insulating layer. Further, given the thinness of the sealing layer, the sealing layer may break off when subject to extreme conditions within the combustion chamber.

### SUMMARY

The present disclosure provides a sealing layer that fills in gaps or crevices along an outer edge of the insulating layer. For example, the sealing layer may be made of a fine powder that fills in the gaps and/or crevices along the edge of the insulating layer, providing a more robust surface contact between the insulating layer and sealing layer, so that the sealing layer effectively bonds to a substantial majority of the outer surface of the insulating layer.

In one example, a thermal barrier coating is provided that may be applied to a surface of one or more components within an internal combustion engine. The thermal barrier coating is bonded to the component(s) of the engine to provide low thermal conductivity and low heat capacity insulation that is sealed against combustion gasses. The thermal barrier coating includes an insulating layer and a sealing layer disposed on the insulating layer, wherein the sealing layer fills in crevices along the edge of the insulating layer.

The thermal barrier coating, or multi-layer thermal barrier coating, may include two, three, four, or more layers, bonded to one another, with at least an insulating layer and a sealing layer. A bonding layer may also be provided under the insulating layer, in which case, the insulating layer would be disposed between the bonding layer and the sealing layer. The innermost layer is bonded to the component.

The thermal barrier coating has a low thermal conductivity to reduce heat transfer losses and a low heat capacity so that the surface temperature of the thermal barrier coating tracks the gas temperature in the combustion chamber. Thus, the thermal barrier coating allows surface temperatures of the component to swing with the gas temperatures. This reduces heat transfer losses without affecting the engine's breathing capability and without increasing knocking tendency. Further, heating of cool air entering the cylinder of the engine is reduced. Additionally, exhaust temperature is increased, resulting in faster catalyst light off time and improved catalyst activity.

In one form, which may be combined with or separate from the other forms described herein, a multi-layer thermal barrier coating is provided that includes at least an insulating layer and a sealing layer. The insulating layer comprises a plurality of hollow round microstructures bonded together and defining an outer layer of microstructures disposed along an outer edge of the insulating layer. The outer layer of microstructures defines a plurality of crevices between adjacent microstructures along the outer edge. The sealing layer is bonded to the outer layer of microstructures, the sealing layer being substantially non-permeable and configured to seal against the outer layer of microstructures. The sealing layer fills in at least a portion of the crevices.

In another form, which may be combined with or separate from the other forms disclosed herein, a multi-layer thermal barrier coating is provided that includes a bonding layer, an insulating layer, and a sealing layer. The bonding layer is configured to be bonded to a metal substrate. The insulating layer is bonded to the bonding layer, the insulating layer having an outer surface defining a plurality of crevices therein. The sealing layer is bonded to the outer surface of the insulating layer. The sealing layer is substantially non-permeable and configured to seal against the insulating layer. The sealing layer fills in at least a portion of the crevices.

In yet another form, which may be combined with or separate from the other forms disclosed herein, a method of forming a thermal barrier coating is provided. The method includes a step of providing a plurality of hollow round microstructures bonded together, each having a diameter in the range of 10 to 100 microns, to create an insulating layer. The method further includes a step of depositing a plurality of metal particles onto the insulating layer, and the method includes a step of heating the plurality of metal particles to form a substantially non-permeable sealing layer over the insulating layer.

Additional features may optionally be provided, including but not limited to the following: the sealing layer being formed of a plurality of metal particles; the sealing layer having a sealing layer melting point and the insulating layer having an insulating layer melting point, the sealing layer melting point being lower than the insulating layer melting point; each microstructure consisting essentially of nickel; the sealing layer being comprised of an alloy formed of nickel and copper; wherein each metal particle is smaller than each microstructure of at least a substantial majority of the microstructures; the sealing layer extending outward from the insulating layer by no more than 5 microns; the insulating layer having a thickness between 75 and 300 microns; each microstructure having a width or diameter not greater than 100 microns; each microstructure having a width or diameter in the range of about 40 to about 50 microns; a bonding layer configured to be bonded to a metal substrate; the insulating layer being bonded to the bonding layer; the bonding layer comprising a copper-based material, a zinc-based material, an alloy comprising copper and zinc, or any other desirable material, preferably having a lower melting temperature than the insulating layer and that improves bonding to the substrate; each microstructure comprising a nickel-based material and/or an iron-based material; and the insulating layer having a porosity of at least 90%.

Further additional features may be provided, including but not limited to the following: providing the plurality of hollow round microstructures to define an outer layer of microstructures disposed along an outer edge of the insulating layer; the outer layer of microstructures defining a plurality of crevices between adjacent microstructures along the outer layer; disposing at least a portion of the plurality of metal particles within the crevices; providing a bonding layer configured to be bonded to a metal substrate; bonding the insulating layer to the bonding layer; and performing the step of heating the sealing layer by laser scanning, laser welding, radiation, or inductive heating.

Furthermore, a component comprising a metal substrate presenting a surface may be provided, with a version of the thermal barrier coating being bonded to the surface of the substrate. The component may be a valve face or a piston crown, by way of example. In addition, the present disclosure contemplates an internal combustion engine comprising such a component having any version of the thermal barrier coating disposed thereon or bonded thereto, wherein the component is configured to be subjected to combustion gasses.

The above features and advantages and other features and advantages of the present teachings are readily apparent from the following detailed description for carrying out the present teachings when taken in connection with the accompanying drawings.

### BRIEF DESCRIPTION OF THE DRAWINGS

The drawings described herein are for illustration purposes only and are not intended to limit the scope of the present disclosure in any way.

FIG. 1 is a schematic side cross-sectional view of a portion of a propulsion system having a cylinder of an internal combustion engine including a thermal barrier coating disposed on a plurality of components, in accordance with the principles of the present disclosure;

FIG. 2 is a schematic side cross-sectional view of one example of the thermal barrier coating disposed on the components of FIG. 1, according to the principles of the present disclosure;

FIG. 3 is a close-up schematic cross-sectional side view of a portion of the thermal barrier coating of FIG. 2, taken along the line 3-3, in accordance with the principles of the present disclosure;

FIG. 4 is a schematic cross-sectional side view of another example of the thermal barrier coating disposed on the components of FIG. 1, according to the principles of the present disclosure; and

FIG. 5 is block diagram illustrating a method of forming a thermal barrier coating, according to the principles of the present disclosure.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims.

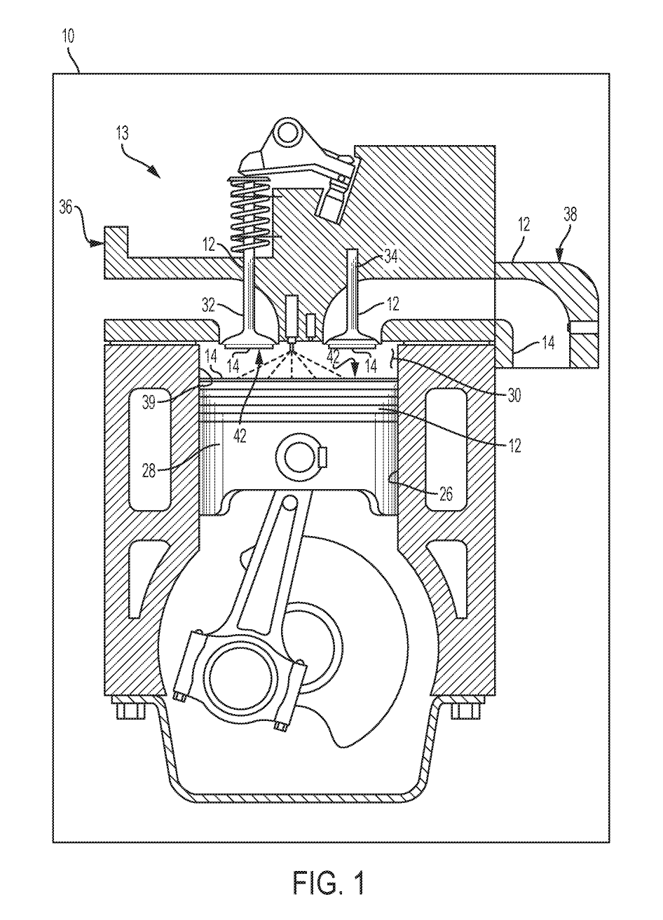

Referring to the drawings, wherein like reference numbers refer to like components throughout the views, FIG. 1 shows a portion of an example vehicle propulsion system 10 that includes an engine 13 having a component 12. The component 12 has a thermal barrier “coating” (TBC) 14 of the type disclosed herein, applied thereto. The thermal barrier coating 14 may be referred to as a composite thermal barrier coating or multi-layer thermal barrier in forms that have multiple layers bonded together. For example, the TBC 14 may be an engineered surface comprised of a plurality of layers, which is described in further detail below.

While the engine 13 of FIG. 1 is a typical example application suitable for the thermal barrier coating 14 disclosed herein, the present design is not limited to vehicular and/or engine applications. Stationary or mobile, machine or manufacture, in which a component thereof is exposed to heat, may benefit from use of the present design.

FIG. 1 illustrates an engine 13 defining a single cylinder 26. However, those skilled in the art will recognize that the present disclosure may also be applied to components 12 of engines 13 having multiple cylinders 26. Each cylinder 26 defines a combustion chamber 30. The engine 13 is configured to provide energy for the propulsion system 10 of the vehicle. The engine 13 may include but is not limited to a diesel engine or a gasoline engine.

The engine 13 further includes an intake assembly 36 and an exhaust manifold 38, each in fluid communication with the combustion chamber 30. The engine 13 includes a reciprocating piston 28, slidably movable within the cylinder 26.

The combustion chamber 30 is configured for combusting an air/fuel mixture to provide energy to the propulsion system 10. Air may enter the combustion chamber 30 of the engine 13 by passing through the intake assembly 36, where airflow from the intake manifold into the combustion chamber 30 is controlled by at least one intake valve 32. Fuel is injected into the combustion chamber 30 to mix with the air, or is inducted through the intake valve(s) 32, which provides an air/fuel mixture. The air/fuel mixture is ignited within the combustion chamber 30. Combustion of the air/fuel mixture creates exhaust gas, which exits the combustion chamber 30 and is drawn into the exhaust manifold 38. More specifically, airflow (exhaust flow) out of the combustion chamber 30 is controlled by at least one exhaust valve 34.

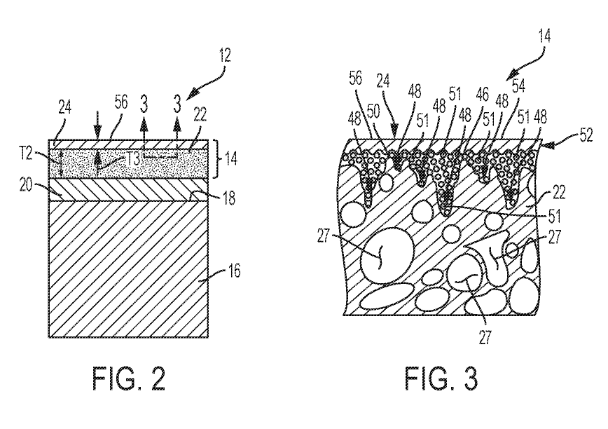

With reference to FIGS. 1 and 2, the thermal barrier coating 14 may be disposed on a face or surface of one or more of the components 12 of the engine 13, e.g., the piston 28, the intake valve 32, exhaust valve 34, interior walls of the exhaust manifold 38 and/or the combustion dome 39, and the like. The thermal barrier coating 14 is bonded to the component 12 to form an insulator configured to reduce heat transfer losses, increase efficiency, and increase exhaust gas temperature during operation of the engine 13. The thermal barrier coating 14 is configured to provide low thermal conductivity and low heat capacity. The low thermal conductivity reduces heat transfer losses, and the low heat capacity results in the surface of the thermal barrier coating 14 tracking with the temperature of the gas during temperature swings, and heating of cool air entering the cylinder is minimized.

Referring to FIG. 2, each component 12 includes a substrate 16 presenting a surface 18, and the thermal barrier coating 14 is bonded to the surface 18 of the substrate 16. The thermal barrier coating 14 may include two, three, four, or more layers, by way of example. In FIG. 2, the thermal barrier coating 14 includes three layers, e.g., an optional first (bonding) layer 20, a second (insulating) layer 22, and a third (sealing) layer 24.

The bonding layer 20 is configured to bond to the surface 18 of the substrate 16 and to the insulating layer 22, such that the insulating layer 22 is attached to the substrate 16. In one non-limiting example, the bonding layer 20 is configured to diffuse into the surface 18 of the substrate 16 and into the insulating layer 22 to form bonds therebetween.

In one non-limiting example, the substrate 16 comprises an alloy of aluminum, the insulating layer 22 comprises nickel or iron, and the bonding layer 20 comprises copper and/or brass (a copper-zinc (Cu—Zn) alloy material). Copper and/or brass create optimum bonding strength, optimum thermal expansion characteristics, heat treatment processes, fatigue resistance, and the like. In addition, copper and/or brass have good solid solubility in aluminum, nickel, and iron, while iron and nickel have very low solid solubility in aluminum. Thus, a bonding layer 20 having copper and/or brass combinations provides an intermediate structural layer that promotes diffusion bonding between the adjacent aluminum substrate 16 and the adjacent nickel or iron insulating layer 22. It should be appreciated, however, that the substrate 16, insulating layer 22, and bonding layer 20 are not limited to aluminum, nickel, iron, copper, and brass, but may comprise other materials. For example, in another variation, the substrate 16 includes or is substantially comprised of iron.

One side of the bonding layer 20 may be disposed across the surface 18 of the substrate 16, such that the bonding layer 20 is disposed between the substrate 16 and the insulating layer 22. A compressive force may be applied to the insulating layer 22 and the substrate 16, at a bonding temperature, for at least a minimum apply time. The melting temperature of the material of the bonding layer 20 is less than the melting temperature of each of the substrate 16 and the material of the insulating layer 22. In another example, the melting temperature of the material of the bonding layer 20 is between the melting temperature of each of the substrate 16 and the material of the insulating layer 22. Further, the required bonding temperature may be less than the melting temperature of the material of the substrate 16 and the material of the insulating layer 22, but sufficiently high enough to encourage diffusion bonding to occur between the metallic material of the substrate 16 and the metallic material of the bonding layer 20 and between the metallic material of the bonding layer 20 and the metallic material of the insulating layer 22.

It should be appreciated that the bonding layer 20 may be bonded to an inner surface of the insulating layer 22 prior to bonding the bonding layer 20 to the surface 18 of the substrate 16. Additionally, the bonding layer 20 is not limited to being bonded to the surface 18 of the substrate 16 and/or the insulating layer 22 with solid-state diffusion, as other methods of adhesion may also be used, such as by wetting, brazing, and combinations thereof. It should be appreciated that any desired number of bonding layers 20 may be applied, providing the desired characteristics, so long as the bonding layer 20 as a whole bonds to the insulating layer 22 and to the substrate 16.

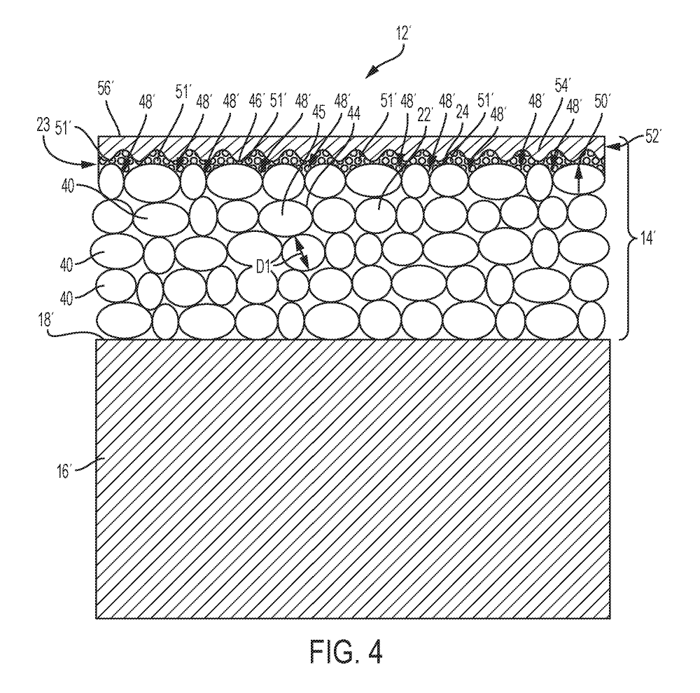

The insulating layer 22 may comprise a ceramic material, such as zirconia, stabilized zirconia, alumina, silica, rare earth aluminates, oxide perovskites, oxide spinels, and titanates. In other variations, the insulating layer 22 may be formed of porous aluminum oxide, or the insulating layer 22 may be formed of a metal, such as iron or nickel. In some variations, the insulating may comprise a plurality of hollow microstructures bonded together, which is shown and described with greater detail with reference to FIG. 4.

The insulating layer 22 may have a porosity in the range of 50% to 90%, and in some cases, the porosity of the insulating layer exceeds 90%, or even 95%. Preferably, the porosity of the insulating layer 22 is at least 80%, in some cases it is preferable that the porosity of the insulating layer 22 is at least 90%, and furthermore, in some cases, it is preferable that the porosity of the insulating layer 22 is at least 95%. The high porosity provides for a corresponding volume of air and/or gasses to be contained therein, thus providing the desired insulating properties of low effective thermal conductivity and low effective heat capacity. The insulating layer 22 is preferably formed of a material having a low effective thermal conductivity, such as in the range of 0.1 to 5 W/mK, and from a material having a coefficient of thermal expansion similar to that of the substrate 16.

The insulating layer 22 could be applied by thermal spray techniques, such as air plasma spray or high velocity oxy-fuel plasma spray. In the case of a porous aluminum oxide insulating layer 22, the insulting layer 22 may be formed by anodizing.

To achieve the desired thermal barrier performance, the thickness of the insulating layer 22 may be tailored for specific applications. For example, a greater thickness T2 could be used if the insulating layer 22 is comprised of a material having a higher thermal conductivity, and a lesser thickness T2 could be used if the insulating layer 22 is comprised of a material having a lower thermal conductivity. In some examples, the insulating layer 22 has a thickness T2 in the range of 50 to 1000 microns, or in the range of 50 to 500 microns, or in the range or in the range of 75 to 300 microns. In some variations, the insulating layer 22 is not greater than 250 microns.

The insulating layer 22 is configured to withstand pressures of at least 80 bar, and in some cases at least 100 bar, or even at least 150 bar. Additionally, with respect to temperature, the insulating layer 22 is configured to withstand surface temperatures of at least 500 degrees Celsius (° C.), or at least 800° C., or even at least 1,100° C. The heat capacity of the thermal barrier coating 14 may be configured to ensure that the surface 18 of the substrate 16 does not get above 300° C.

The sealing layer 24 is disposed over the insulating layer 22, such that the insulating layer 22 is disposed between the sealing layer 24 and either the bonding layer 20 of the surface 18 or of the substrate 16. The sealing layer 24 is a high temperature, thin film. More specifically, the sealing layer 24 comprises material that is configured to withstand temperatures of at least 1,100° C. In some forms, the sealing layer 24 may be formed of a metallic material, such as stainless steel, nickel, iron, nickel alloy, cobalt alloy, refractory alloy, a nickel-copper alloy, or any other desired metal or other desired material.

The sealing layer 24 is substantially non-permeable (or has very low permeability) to combustion gasses, such that a seal is provided between the sealing layer 24 and the insulating layer 22. For example, the sealing layer 24 may be no more than 10% porous. Such a seal prevents debris from combustion gasses, such as unburned hydrocarbons, soot, partially reacted fuel, liquid fuel, and the like, from entering the porous structure of the insulating layer 22. If such debris were allowed to enter the porous structure, air disposed in the porous structure could end up being displaced by the debris, and the insulating properties of the insulating layer 22 could be reduced or eliminated. Also, if gases are able to penetrate during each combustion cycle, the insulating quality of the insulating layer 22 is much less. Therefore, the sealing layer 24 is preferably substantially impermeable to gases, as well as to solids.

In one non-limiting example, the sealing layer 24 may be applied to the insulating layer 22 via electroplating or vapor deposition, or by another process of applying a powder material. In another non-limiting example, the sealing layer 24 may be applied to the insulating layer 22 simultaneously with sintering the insulating layer 22.

The sealing layer 24 is configured to be sufficiently resilient so as to resist fracturing or cracking during exposure to combustion gasses, thermal fatigue, or debris. Further, the sealing layer 24 is configured to be sufficiently resilient so as to withstand expansion and/or contraction of the underlying insulating layer 22.

In some forms, the sealing layer 24 is thin, with a thickness T3 not greater than 20 microns, and in some cases, not greater than 5 microns. However, in some cases, the thickness T3 of the sealing layer 24 may be as great as 50 microns, by way of example. Thus, for example, T3 may be in the range of 3 to 50 microns.

FIG. 3 provides a close-up cross-sectional view taken along the lines 3-3 in FIG. 2. Referring to FIGS. 2 and 3, as explained above, the insulating layer 22 is formed of a porous material. As such, the insulating layer 22 has a plurality of pores 27 formed therein, and the insulating layer 22 has an outer surface 46 defining a plurality of crevices 48 therein. The crevices 48 are gaps or cracks in the outer surface 46 of the insulating layer 22, which may be formed by the existence of pores 27 at the surface 46.

The sealing layer 24 fills in at least a portion of the crevices 48 in the outer surface 46 of the insulating layer 22. For example, the sealing layer 24 may be formed of metal particles 51, such as a metal powder. The metal particles 51 may be deposited in the crevices 48 of the outer surface 46 of the insulating layer 22. To form the sealing layer 24, the sealing layer 24 may be heated to melt an outer portion 52 of the metal particles 51, forming the outer portion 52 of the metal particles into a continuous surface 54 at the outer edge 56 of the sealing layer 24.

Referring now to FIG. 4, the component of FIG. 1 (labeled as 12′ here) is illustrated again with another variation of the thermal barrier coating 14′ disposed thereon. Again, the component 12′ includes a substrate 16′ presenting a surface 18′, and the thermal barrier coating 14′ is bonded to the surface 18′ of the substrate 16′. In this example, the thermal barrier coating 14′ includes two layers: an insulating layer 22′ and a sealing layer 24′. The bonding layer 20 is omitted, and the insulating layer 22′ is bonded directly to the surface 18′ of the substrate 16′; however, it should be understood that the bonding layer 20 shown in FIG. 2 could be included between the insulating layer 22′ and the substrate 16′, if desired.

In the variation of FIG. 4, the insulating layer 22′ includes a plurality of hollow microstructures 40, bonded or sintered together to create a layer having an extremely high porosity. Preferably, the porosity of the insulating layer 22′ is at least 80%. More preferably, the porosity of the insulating layer 22′ is at least 90%, or even 95%. The high porosity provides for a corresponding volume of air and/or gases to be contained therein, thus providing the desired insulating properties of low effective thermal conductivity and low effective heat capacity.

In one example, the hollow microstructures 40 may be comprised of hollow polymer, metal, glass, and/or ceramic centers 45, which may be, or may start off as being, spherical, elliptical, or oval in shape. Thus, in some examples, the microstructures 40 are round. At least one metallic coating layer 44 may be disposed on an exterior surface of each hollow center 45; in some cases, a first metal coating may be overcoated with a second metal coating. The metallic coating layer 44 may include nickel (Ni), iron, or the like, alone or in combination. The metallic coating layer 44 may be disposed on the exterior surface of the microstructures 40 via electroplating, flame spraying, painting, electroless plating, vapor deposition, or the like.

It should be appreciated that during the bonding or sintering of the metallic coated microstructures 40, the hollow centers 45 that are comprised of polymer, metal, and glass having a melting temperature that is less than that of the metallic coating layer 44, and therefore, the hollow centers 45 may melt or otherwise disintegrate to become part of the metallic coating layer 44 itself, or melt and turn into a lump of material within the hollow microstructure 40. However, when the melting temperature of the hollow center 45 is higher than the melting temperature of the material of the metallic coating layer 44, such as when the hollow center 45 is formed from a ceramic material, the hollow center 45 remains intact and does not disintegrate or become absorbed.

In instances where the hollow centers 45 are formed from polymer, metal, and glass, the hollow center 45 may melt as a function of a material properties of the hollow center 45 and a sintering temperature applied to the microstructures 40. Therefore, when melting of the hollow centers 45 occurs, the metallic coating layer 44 is no longer a “coating”, but rather becomes an inner wall of the microstructure 40. Thus, in some examples, the microstructures 40 may be thin-walled hollow metal structures without anything in their centers.

In examples where the microstructures 40 are round or elliptical, such as shown in FIG. 4, the hollow microstructures 40 may have a diameter D1 of between 5 and 100 microns, between 20 and 100 microns, or between 20 and 40 microns, by way of example. In another example, the diameter D1 is between about 40 and about 50 microns. It should be appreciated that the microstructures 40 do not necessarily have the same diameter, as a mixture of diameters may be configured to provide a desired open porosity, e.g., packing density, to provide a desired amount of strength to the insulating layer 22′.

The plurality of the hollow microstructures 40 may be molded or sintered at a sintering temperature, under pressure, for a molding time, until bonds are formed between the coating layers 44 of adjacent hollow microstructures 40 forming the insulating layer 22′.

The insulating layer 22′ defines an outer layer 23 of microstructures 40 disposed along an outer edge 46′ of the insulating layer 22′. The outer layer 23 of microstructures 40 defines a plurality of crevices 48′ between adjacent microstructures 40 along the outer edge 46′. The crevices 48′ are gaps between adjacent microstructures 40 along the outer edge 46′ of the insulating layer 22′. Thus, the crevices 48′ are located between walls 44 of adjacent microstructures 40 and extend into the insulating layer 22′ from an outermost part of the outer edge 46′.

The sealing layer 24′ fills in at least a portion of the crevices 48′ along the outer edge 46′ of the outer layer 23 of the microstructures 40 of the insulating layer 22′. For example, the sealing layer 24′ may be formed of metal particles 51′, and the metal particles 51′ may be deposited in the crevices 48′ of the outer layer 23 of microstructures 40. Each of the metal particles 51′ may be smaller than each, or most, of the microstructures 40, so that the metal particles 51′ can fill in the crevices 48′ between the microstructures 40. An outer portion 52′ of the sealing layer 24′ may be melted together into a continuous surface 54′ at an outer edge 56′ of the sealing layer 24′.

To form the sealing layer 24′, the metal particles 51′ may be deposited along the outer edge 56′ of the insulating layer 22′, including in the crevices 48′. Then, the metal particles 51′ may be heated to melt an outer portion 52′ of the metal particles 51′, thereby forming the outer portion 52′ of the metal particles 51′ into a continuous surface 54′ at the outer edge 56′ of the sealing layer 24′.

The sealing layer 24′ is bonded to the outer layer 23 of microstructures 40. The sealing layer 24′ is substantially non-permeable and is configured to seal against the outer layer 23 of microstructures 40, and the sealing layer 24′ fills in at least a portion of the crevices 48′.

Referring to the versions of the thermal barrier coating 14, 14′ shown in both of FIGS. 3 and 4, the sealing layer 24, 24′ has a sealing layer melting point and the insulating layer 22, 22′ has an insulating layer melting point. The sealing layer melting point is lower than the insulating layer melting point. Therefore, during the heating of the outer portion 52, 52′ of the metal particles 51, 51′, the metal particles 51, 51′ may be melted to form the continuous surface 54, 54′ without melting the microstructures 40 or other configuration (as in FIG. 2) of the insulating layer 22, 22′. For example, the microstructures 40 or other configuration (as in FIG. 2) of the insulating layer 22, 22′ may consist essentially of nickel, which has a melting point of about 1453° C. A nickel-copper alloy may be used for the metal particles 51, 51′, and thus, the sealing layer 24, 24′ may have a melting point of between 1085 and 1452° C., depending on the amount of copper included. Accordingly, the heating of the sealing layer 24, 24′ may be performed at a temperature between the melting points of the insulating layer 22, 22′ and the sealing layer 24, 24′ to melt the outer portion 23, 23′ of the metal particles 51, 51′ of the sealing layer 24, 24′ without melting the insulating layer 22, 22′.

Other materials may alternatively be used for the insulating layer 22, 22′ and the sealing layer 24, 24′. For example, the insulating layer 22, 22′ may be formed of a nickel alloy containing cobalt, chromium, molybdenum, tungsten, iron, and magnesium, as well as small amounts of other elements, such as the nickel alloy sold under the registered trademark Hastelloy® and labeled as a C-276 composition. In other forms, stainless steel, tungsten, Mo, Mn, Cr, and alloys of these may be used to form the insulating layer 22, 22′. Preferably, the material of the sealing layer 24, 24′ compliments the insulating 22, 22′ by having a lower melting point than the material of the insulating layer 22, 22′. Therefore, in one example, the insulating layer 22, 22′ (or the microstructures 40 comprising it) may be formed of chromium, and the sealing layer 24, 24′ may be formed of a manganese/chromium alloy. In another example, a molybdenum insulating layer 22, 22′ may be used with a molybdenum/titanium sealing layer 24, 24′. In another example, a molybdenum insulating layer 22, 22′ may be used with a molybdenum/nickel sealing layer 24, 24′. These are just a few possible examples; other combinations of materials are possible, such as ternary and many other multi-component alloys.

The sealing layer 24, 24′ may extend outward from the insulating layer 22, 22′ by a relatively short distance, such as no more than 5 microns, while the entire depth of the sealing layer 24, 24′ may extend down much deeper into the crevices 48, 48′. Thus, the sealing layer 24, 24′ may be strengthened with more material in the crevices 48, 48′, and with more material being bonded to the surfaces of the outer layer 23 of microstructures 40, without adding to the thickness of the sealing layer 24 at the peaks 50′ of the microstructures 40, or at the outermost parts 50 of the outer surface 46 of the insulating layer 22 of FIG. 3.

Though not shown, the sealing layer 24, 24′ could also include more than one layer to provide desired properties, e.g., super-high temperature resistance and corrosion resistance. For example, a separate top layer could form the continuous portion 52, 52′ over the rest of the metal particles 51, 51′, if desired.

It should be understood that any of the variations, examples, and features described with respect to one of the thermal barrier coatings 14, 14′ described herein may be applied to one of the other thermal barrier coatings 14, 14′ described herein. The thermal barrier coatings 14, 14′ may be formed in any suitable way, which may include heating the insulating layer 22, 22′, the bonding layer 20, and the sealing layer 24, 24′, such as by sintering.

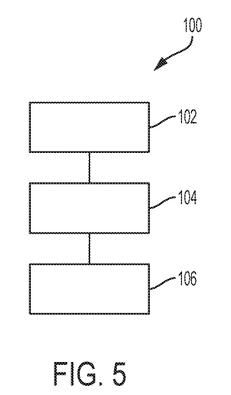

Referring to FIG. 5, and with continued reference to FIG. 4, one method of forming the thermal barrier coating 14′ is illustrated and generally designated at 100. It should be understood that some portions of the described method 100 may also be used to form the thermal barrier coating 14 shown in FIGS. 2-3.

The method 100 includes a step 102 of providing a plurality of hollow round microstructures bonded together, each having a diameter in the range of 10 to 100 microns, to create an insulating layer, such as the insulating layer 22′ shown and described with respect to FIG. 4. Further, the insulating layer 22′ is preferably provided having a porosity of at least 90%, as explained above. A bonding layer may also be optionally provided, such as the bonding layer 20 shown in FIG. 2, where the bonding layer 20 is configured to be bonded to a metal substrate 16. If the bonding layer 20 is included, the method 100 may include bonding the insulating layer 22, 22′ to the bonding layer 20.

The method 100 includes another step 104 of depositing a plurality of metal particles, such as the metal particles 51′ shown in FIG. 4, onto the insulating layer, such as the insulating layer 22′. The metal particles 51′ are preferably smaller than the hollow round microstructures 40, so that the metal particles 51′ at least partially fill in the gaps, and are disposed in the crevices 48′, defined between the microstructures 40 along the outer edge 46′ of the insulating layer 22′.

The method 100 further includes a step 106 of heating the plurality of metal particles 51′ to form a substantially non-permeable sealing layer 24′ over the insulating layer 22′. The sealing layer 24′, and the metal particles 51′ that the sealing layer 24′ is made from, is preferably provided having a sealing layer melting point that is lower than a melting point of the insulating layer 22′. For example, the hollow round microstructures 40 could be formed of pure nickel having a melting point of 1453° C., and the metal particles 51′ could formed of a nickel-copper alloy, which has a melting point between 1085 and 1453° C., depending on the copper content of the alloy. Accordingly, when heat is applied to the outer side 56′ of the sealing layer 24′, the metal particles 51′ melt together to form the continuous surface 54′ without damaging or melting the hollow round microstructures 40. The continuous surface 54′ may then be similar to a weld or clad microstructure. The heating of the metal particle 51′ can be applied via laser scanning, laser welding, radiation, inductive heating, and/or additive manufacturing techniques. The sealing layer 24′ is preferably melted quickly and solidified before the hollow microstructures 40 are damaged or destroyed, though the outermost microstructures 40 may have signs of melting and solidification. Within the crevices 48′, some of the metal particles 51′ may remain unmelted and keep their original form. Additional diffusion bonding to the underlying structure 16 can be carried out at lower temperatures.

It should be appreciated that the thermal barrier coatings 14, 14′ described herein may be applied to components other than those present within an internal combustion engine. More specifically, the thermal barrier coatings 14, 14′ may be applied to components of space crafts, rockets, injection molds, and the like.

The detailed description and the drawings or figures are supportive and descriptive of the disclosure, but the scope of the disclosure is defined solely by the claims. While some examples for carrying out the claimed disclosure have been described in detail, various alternative designs and examples exist for practicing the disclosure defined in the appended claims. Furthermore, the examples shown in the drawings or the characteristics of various examples mentioned in the present description are not necessarily to be understood as examples independent of each other. Rather, it is possible that each of the characteristics described in one example can be combined with one or a plurality of other desired characteristics from other examples, resulting in other examples not described in words or by reference to the drawings. Accordingly, such other examples fall within the framework of the scope of the appended claims.

What is claimed is:

1. A multi-layer thermal barrier coating comprising:
an insulating layer comprising a plurality of hollow round microstructures bonded together and defining an outer layer of microstructures disposed along an outer edge of the insulating layer, the outer layer of microstructures defining a plurality of crevices between adjacent microstructures along the outer edge; and
a sealing layer bonded to the outer layer of microstructures, the sealing layer being substantially non-permeable and configured to seal against the outer layer of microstructures, the sealing layer filling in at least a portion of the crevices.

2. The multi-layer thermal barrier coating of claim 1, wherein the sealing layer is formed of a plurality of metal particles.

3. The multi-layer thermal barrier coating of claim 2, wherein the sealing layer has a sealing layer melting point and the insulating layer has an insulating layer melting point, the sealing layer melting point being lower than the insulating layer melting point.

4. The multi-layer thermal barrier coating of claim 2, wherein each microstructure of the plurality of hollow round microstructures consists essentially of nickel, and the sealing layer is comprised of an alloy formed of nickel and copper.

5. The multi-layer thermal barrier coating of claim 4, wherein each metal particle of the plurality of metal particles is smaller than each microstructure of at least a substantial majority of the plurality of hollow round microstructures.

6. The multi-layer thermal barrier coating of claim 5, wherein the sealing layer extends outward from the insulating layer by no more than 5 microns, wherein the insulating layer has a thickness between 75 and 300 microns, and wherein each microstructure of the plurality of hollow round microstructures has a width not greater than 100 microns.

7. The multi-layer thermal barrier coating of claim 1, further comprising a bonding layer configured to be bonded to a metal substrate, the insulating layer being bonded to the bonding layer.

8. The multi-layer thermal barrier coating of claim 7, wherein the bonding layer comprises at least one of a copper-based material, an aluminum based material, a zinc-based material, and an alloy comprising copper and zinc, and wherein each microstructure of the plurality of hollow round microstructures comprises at least one of a nickel-based material and an iron-based material.

9. The multi-layer thermal barrier coating of claim 1, wherein the insulating layer has a porosity of at least 90%.

10. A component comprising a metal substrate presenting a surface, the multi-layer thermal barrier coating of claim 1 being bonded to the surface.

11. An internal combustion engine comprising a component configured to be subjected to combustion gasses, the component having the multi-layer thermal barrier coating of claim 1 bonded thereto.

12. A multi-layer thermal barrier coating comprising:
a bonding layer configured to be bonded to a metal substrate;
an insulating layer bonded to the bonding layer, the insulating layer having an outer surface defining a plurality of crevices therein; and
a sealing layer bonded to the outer surface of the insulating layer, the sealing layer being substantially non-permeable and configured to seal against the insulating layer, the sealing layer filling in at least a portion of the crevices.

13. The multi-layer thermal barrier coating of claim 1, wherein the sealing layer is formed of a plurality of metal particles, the sealing layer having a sealing layer melting point and the insulating layer having an insulating layer melting point, the sealing layer melting point being lower than the insulating layer melting point.

14. A method of forming a thermal barrier coating, the method comprising:
providing a plurality of hollow round microstructures bonded together, each having a diameter in the range of 10 to 100 microns to create an insulating layer;
depositing a plurality of metal particles onto the insulating layer; and
heating the plurality of metal particles to form a substantially non-permeable sealing layer over the insulating layer.

15. The method of claim 14, further comprising:
providing the plurality of hollow round microstructures to define an outer layer of microstructures disposed along an outer edge of the insulating layer, the outer layer of microstructures defining a plurality of crevices between adjacent microstructures along the outer layer; and
disposing at least a portion of the plurality of metal particles within the crevices.

16. The method of claim 15, further comprising:
providing the plurality of metal particles having a sealing layer melting point; and
providing the plurality of round hollow microstructures having an insulating layer melting point, the sealing layer melting point being lower than the insulating layer melting point.

17. The method of claim 15, further comprising:
forming each microstructure of substantially pure nickel; and
forming each metal particle of a nickel-copper alloy.

18. The method of claim 17, further comprising providing each metal particle of the plurality of metal particles as being smaller than each microstructure of at least a substantial majority of the plurality of hollow round microstructures.

19. The method of claim 18, further comprising:
providing the insulating layer having a porosity of at least 90%;
providing a bonding layer configured to be bonded to a metal substrate; and
bonding the insulating layer to the bonding layer.

20. The method of claim 16, further comprising performing the step of heating by one of laser scanning, laser welding, radiation, and inductive heating.
